(19) United States
(12) Patent Application Publication
(10) Pub. No.: US 2024/0258546 A1
(43) Pub. Date: Aug. 1, 2024

(54) OXYFUEL HYBRID ELECTRIC VEHICLE

(71) Applicant: Jared Moore, Houston, TX (US)

(72) Inventor: Jared Moore, Houston, TX (US)

(21) Appl. No.: 18/564,375

(22) PCT Filed: May 27, 2022
(86) PCT No.: PCT/US2022/031341

§ 371 Date: Nov. 27, 2023

Related U.S. Application Data
(60) Provisional application No. 63/193,865, filed on May 27, 2021.

(51) Int. Cl. H01M 8/0668; H01M 8/04007; H01M 8/04082; H01M 8/04089; H01M 8/04186; H01M 8/12

(52) U.S. Cl. CPC H01M 8/0668; H01M 8/04067; H01M 8/04097; H01M 8/04186; H01M 8/04201; H01M 2008/1293

(57) ABSTRACT

An electric vehicle includes a battery and one or more solid oxide fuel cells. A fuel line provides fuel to the solid oxide fuel cell from a first chamber of a fuel tank. An exhaust line returns exhaust fluid from the solid oxide fuel cell to a second chamber of the fuel tank. A refrigeration system is in thermal communication with the exhaust line to remove heat from and condense the exhaust fluid before the exhaust fluid enters the fuel tank.

### CROSS REFERENCE TO RELATED APPLICATIONS

This application claims the benefit of U.S. Provisional Application No. 63/193,865 filed May 27, 2021, which is hereby incorporated by reference.

### BACKGROUND OF THE INVENTION

The present disclosure pertains generally to energy systems and power systems for vehicles and the operation of same. In certain aspects, the present disclosure provides hybrid vehicles, including hybrid electric vehicles. Such hybrid vehicles may include solid oxide fuel cells.

With increased need to protect the environment, there remains a need for energy systems, power systems, and vehicles that are better for the environment than existing systems (e.g., internal combustion engines). Thus, there is a need for improvement in this field.

### SUMMARY OF THE INVENTION

The present disclosure pertains generally to energy systems and power systems for vehicles and the operation of same. In certain aspects, the present disclosure provides hybrid vehicles, including hybrid electric vehicles. Such hybrid vehicles may include solid oxide fuel cells.

Vehicles of the present disclosure may be plug-in hybrid electric vehicles or non-plug-in hybrid electric vehicles. The hybrid electric vehicles may have one or more fuel cells, preferably including at least one Solid Oxide Fuel Cell (SOFC), which is/are engageable to extend the range of the vehicle when the battery is insufficiently charged (e.g., depleted). The vehicle may also be capable of storing its own byproduct(s) from the fuel cell (e.g., CO₂). The vehicle may have the following major components:
A battery. Preferably the battery is sufficient to achieve at least 40 miles of range for the vehicle.
A fuel tank. The fuel tank preferably has a separator that separates fuel and byproduct from the fuel cell. Fuel (e.g., ethanol or methanol) is preferably stored in the fuel tank in liquid form. Byproduct is preferably stored in the fuel tank, on another side of the separator, in liquid form (e.g., liquid CO₂). As the fuel is used, space may be vacated in the tank, and this space may be used for byproduct from the fuel cell (e.g., CO₂ storage). The separator in the fuel tank may be a flexible membrane and/or a movable piston.
A refrigeration system to cool byproduct from the fuel cell. Preferably the refrigeration system condenses the byproduct from the fuel cell. For example, an absorption refrigeration system, such as an ammonia (NH₃) absorption refrigeration system, may cool and condense byproduct (e.g., CO₂) to a liquid. Condensing may be compression-assisted (e.g., by a compressor).

Each vehicle may contain several (e.g., at least two) fuel cells (e.g., compartments) which may engage separately. Fuel cells may use common or separate heat exchangers.

Preferably, a fuel cell is pre-heated prior to usage in the fuel cell to generate electricity. Advantageously, such an arrangement may minimize transients experienced by the fuel cell. The fuel cell may be preheated using energy from the battery and/or from another fuel cell.

Operational parameters described herein may selectively engage fewer than the total number of fuel cells of the vehicle. For example, the parameters may determine a number of fuel cells to activate to power the vehicle and/or recharge the battery. Preferably, once engaged, the fuel cell(s) operate at a steady state. As one example, one or more fuel cells (e.g., fewer than the total number of fuel cells of the vehicle) may be activated when the battery pack is headed for depletion (e.g., more than half empty or rapidly depleting). Advantageously, this may allow more of the battery to be recharged by the grid, when possible, or to be recharged with fewer fuel cells and/or at a slower rate than charging with the total number of fuel cells of the vehicle.

The energy systems, power systems, and/or vehicles disclosed herein may have one or more of the following features:
1. Transferring heat to, from, and/or between:
   1. one or more fuel cells,
   2. fuel(s) for one or more fuel cells,
   3. air entering one or more fuel cells;
   4. air exiting one or more fuel cells; and/or
   5. byproduct(s) of one or more fuel cells.
   6. Optionally but preferably using a common heat exchanger, such as a radiator, to transfer said heat.
2. Heat fins positioned directly on the fuel cell. The heat fins may be cooled by a liquid, such as liquid CO₂. Alternatively or additionally, the vehicle may use a gas (e.g., air) to cool off the heat fins.
3. Transferring heat into air entering one or more fuel cells from a byproduct of one or more fuel cells (e.g., CO₂). Preferably the heat is transferred from a byproduct in a liquid state (e.g., liquid CO₂).
4. Transferring heat from air exiting one or more fuel cells into air entering one or more fuel cells.
5. Transferring heat from one or more fuel cells (e.g., via heat from fuel cell heat fins and/or heat in air exiting the fuel cell) to an NH₃ generator. Such heat, in some instances, is provided to the NH₃ generator from a fluid (e.g., air) after transferring heat from the fluid for use in heating air entering one or more fuel cells.
6. The system may recirculate at least some byproduct(s) from one or more fuel cells (CO₂ and/or H₂O) for reforming fuel being supplied to one or more fuel cells.
7. Transferring heat from at least some byproduct(s) from one or more fuel cells (CO₂ and/or H₂O) to heat and/or boil fuel being supplied to one or more fuel cells.
8. Transferring heat from at least some byproduct(s) from one or more fuel cells to heat a portion of an absorption refrigeration cycle (e.g., an NH₃ absorption refrigeration cycle). For example, transferring heat from CO₂ exiting one or more fuel cells into NH₃. Preferably, transferring heat from the byproduct(s) sufficiently to condense the byproduct.
9. Transferring heat from one or more fuel cell byproducts (e.g., CO₂ and/or H₂O) into ambient air. Preferably, transferring heat from the byproduct(s) sufficiently to condense the byproduct.
10. Circulating fuel cell byproduct(s) through a fuel cell syngas system to at least partially heat a fuel cell. Preferably circulating during start-up.
11. Using liquid H₂O byproduct from a fuel cell to at least partially cool CO₂ from a fuel cell. Preferably the CO₂ is in liquid form before, during, and/or after said cooling.
12. Transferring heat from one or more fuel cell byproducts (e.g., CO₂ and/or H_{2O}) into one or more other fuel cells. Preferably, transferring heat from the byproduct(s) into another fuel cell prior to condensing the byproduct(s). For example, CO₂ may bypass a CO₂ radiator and may communicate with heat fins of one or more fuel cells to assist with heating the fuel cell during start-up.
13. Transferring heat from one or more fuel cell byproducts (e.g., liquid CO₂ and/or H₂O) to ambient air.
14. Using an analyzer, or cooling, plates which allow further distillation of NH₃ and/or H₂O
15. Using a glycol and water mixture to cool down vapor NH₃ (and causes some additional H₂O to condense)
16. Using liquid CO₂ to cool gaseous CO₂
17. Using liquid CO₂ to cool NH₃ before depressurization
18. Expansion valve(s):
   1. which allow the NH₃ to depressurize after cooling; and/or
   2. which allow the water exiting an NH₃ generator to depressurize
19. Using NH₃ to cool and/or condense gaseous CO₂
20. Using a compressor and/or pump to pressurize CO₂ to 80 bar
21. An absorber where NH₃ is absorbed by H₂O whose heat generation is carried away by a glycol/water heat exchanger
22. A compressor and/or pump which pressurizes an NH₃ and H₂O mixture
23. Using water exiting the NH₃ generator to heat the NH₃ strong H₂O mix leaving the absorber
24. A heat exchanger (e.g., radiator) which cools the glycol/water mix involved with the ammonia absorption refrigeration system
25. Recirculating gases which do not condense in the ammonia absorption refrigeration system.
26. Using the air exiting a fuel cell to pre-heat fuel or to assist NH₃ generation. This air may be directed toward the air side of the tubes in adjacent fuel cells to assist with heating during start-up.
27. Recirculated syngas and CO₂ may be re-heated in the heat exchanger (4b) and then inserted into the fuel cell, entering the fuel cell directly without using reformer tubes. The recirculated syngas may also be directed towards alternate reformer tubes using different catalysts. Recirculated syngas may also bypass some portion of the heat exchanger and injected into the fuel cell interstitially to provide additional cooling to fuel cell “hot spots”. The recirculated syngas and CO₂ may also be recombined with (m)ethanol stream to provide the CO₂ which is needed for reforming, and to reform fuel which may have not reformed during the previous cycle.

### Fuel Cell Structure:

Fuel cells of the present disclosure may use tubular fuel cells with air inside the tube and syngas outside the tube. The tubes may be vertically oriented with some reformer tubes placed to facilitate flow through the fuel cell. The fuel inside the reformer tubes would reform, thus cooling/utilizing waste heat of the fuel cell, and would then receive their final heating inside the fuel cell. This syngas would be redirected outside of the fuel cell before re-entry. Alternatively, reformer tube holes/slits may allow the syngas to enter into the fuel cell directly.

Because fuel cells may suffer from hot spots, it is envisioned that some fuel cell tubes may have recirculated syngas (and CO₂) as described above. This will allow some low temperature syngas to enter the fuel cell which does not require reforming, and this syngas would be released inside the fuel cell box through holes/slits.

Other tubes may be filled with air which are not fuel cells, but are simply tubes used for the final heating stage of air (before entry into the fuel cell for oxygen exchange) and as a means of providing cooling to specific spots of the fuel cell.

### Exemplary Modes of Operation:

Operation of the fuel cell may be determined based on battery charge, fuel amount for the fuel cell, user selectable modes, and/or vehicle speed (e.g., average vehicle speed over a distance, period of time, or battery usage). The following are some exemplary modes of operation.
If more than 40% of the battery capacity is depleted (e.g., 60% or less remaining of battery charge) and during the most recent 25% of the battery charge used the vehicle had an average speed greater than 50 miles per hour, fewer than half of the fuel cells of the vehicle will activate to recharge the battery
If more than 60% of the battery capacity is depleted (e.g., 40% or less remaining of battery charge) and during the most recent 25% of the battery charge used the vehicle had an average speed less than 40 miles per hour, less than half of the fuel cells of the vehicle will activate to recharge the battery
If more than 60% of the battery capacity is depleted (e.g., 40% or less remaining of battery charge) and during the most recent 25% of the battery charge used the vehicle had an average speed greater than 40 miles per hour, more than half of the fuel cells of the vehicle will activate to recharge the battery
If more than 80% of the battery capacity is depleted (e.g., 20% or less remaining of battery charge), all the fuel cells of the vehicle will engage to recharge the battery
Preferably the fuel cell(s) will not activate if the fuel amount for the fuel cell is insufficient to at least partially recharge the battery

The following are exemplary modes of operation for user selectable modes:
If the driver decides to engage “manual mode”, fuel cells will engage at the discretion of the driver
If the driver decides to engage “commuter mode”, fuel cells will not engage until the battery pack has less than 25% of capacity
The driver decides to engage “road trip mode”, one half or fewer of the fuel cells will engage immediately upon the start of the trip, and subsequent fuel cells will engage once the vehicle reaches less than 65% capacity.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a schematic view of a vehicle having a fuel cell system and a battery.

FIG. 2 is a schematic view of a fuel cell system.

FIG. 3 is a schematic view of a fuel cell system with an NH₃ absorption refrigeration cycle.

FIG. 4 is a schematic view of a fuel cell system with exemplary operating temperatures and heat transfer rates.

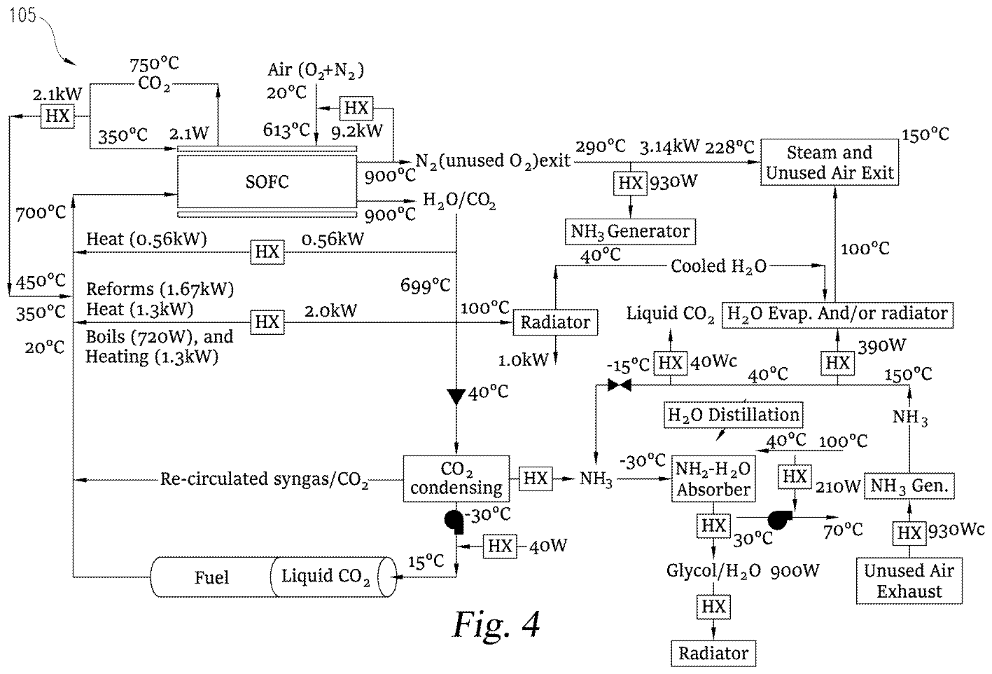

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

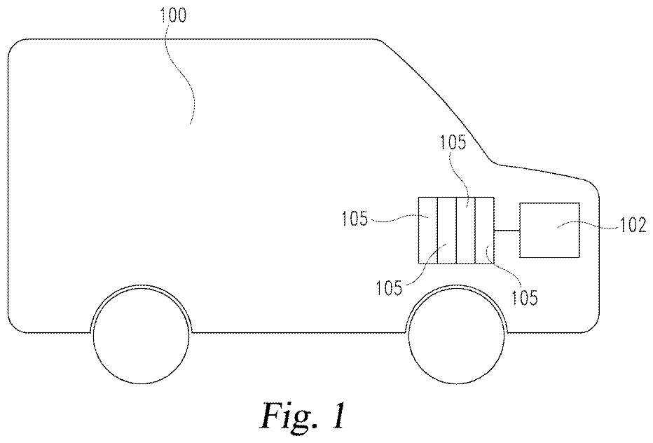

FIG. 1 is a diagram of a hybrid electric vehicle 100 that includes a battery 102 to power one or more electric motors (not shown) of the vehicle 100 and at least one solid oxide fuel cell pack 105 that may be used to provide additional electricity to power the hybrid electric vehicle 100 and/or to at least partially recharge the battery 102. In some embodiments, the hybrid electric vehicle 100 may be a plug-in vehicle that includes multiple solid oxide fuel cell packs 105. These solid oxide fuel cell packs may be used to extend the range of the vehicle 100 when the battery typically used to operate the vehicle is insufficiently charged. This vehicle 100 may also be capable of storing its own carbon dioxide (CO₂) generated from operating the solid oxide fuel cells.

In some embodiments, the vehicle 100 may include a battery that is large enough to achieve at least 40 miles of range. As described in more detail below, the vehicle 100 may also include a fuel tank that has a separator to separate liquid fuel and liquid CO₂. As the liquid fuel is used to operate the solid oxide fuel cell 110, the space in the fuel tank used to store liquid fuel is vacated, and the additional space may be used for CO₂ storage. The solid oxide fuel cells are cooled by an absorption refrigeration system that cools the CO₂ that is created as a byproduct from electricity generation at the solid oxide fuel cells and condenses the CO₂ to a liquid.

Each vehicle 100 may have multiple solid oxide fuel cells which may be collected in “packs”. The solid oxide fuel cells may be separately activatable to provide electricity to power the vehicle 100 and/or at least partially recharge the battery when desired. Each of the solid oxide fuel cells may use common or separate heat exchangers to provide heat management for the solid oxide fuel cell. Advantageously, providing multiple solid oxide fuel cells can allow each solid oxide fuel cell time to warm up and to minimize transient thermal behavior.

As described in further detail below, operational rules may be set for the solid oxide fuel cells to increase efficiency of the system. These operational rules may be used to activate only the minimum number of solid oxide fuel cells when necessary to provide additional power to the vehicle 100, and once these solid oxide fuel cells are activated, to operate at a steady state. In most embodiments, the solid oxide fuel cells will only activate when the battery pack is in danger of depletion, such as when the battery pack is more than half empty or when there is rapid depletion. Operating the solid oxide fuel cells as minimally as necessary allows the battery to be recharged by the grid when possible or to be recharged with fewer solid oxide fuel cells (e.g., when the vehicle stops moving).

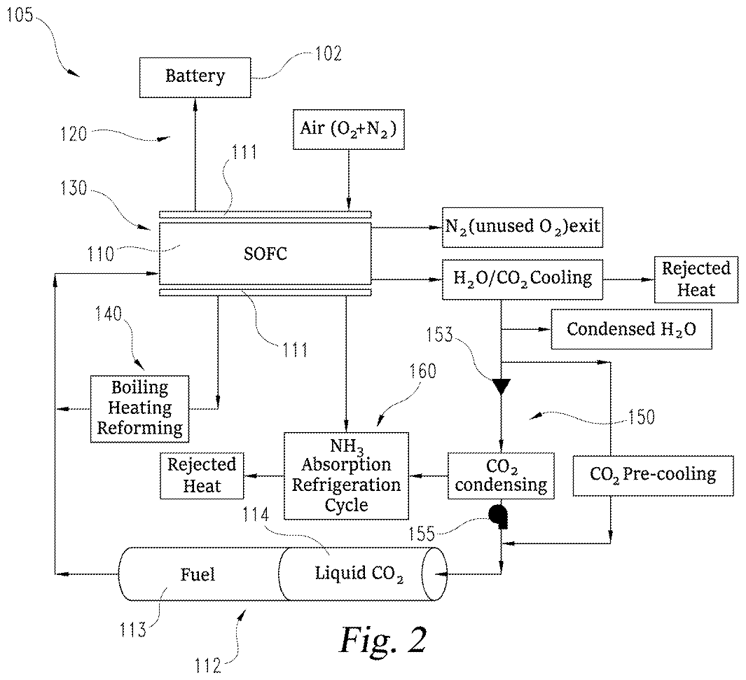

FIG. 2 is a diagram that illustrates a solid oxide fuel cell pack 105 for the hybrid vehicle 100. The solid oxide fuel cell pack 105 includes a solid oxide fuel cell 110 and a fuel tank, such as a dual chamber tank 112. The solid oxide fuel cell 110 oxidizes a fuel to produce electricity. In the embodiment shown, the fuel used for the solid oxide fuel cell 110 is methanol or ethanol, but in other embodiments, other suitable fuels may be used. The solid oxide fuel cell 110 includes a solid oxide electrolyte to conduct oxygen ions from a cathode of the solid oxide fuel cell 110 to an anode of the solid oxide fuel cell 110.

The dual chamber tank 112 includes a first chamber 113 and a second chamber 114. The two separate chambers 113, 114 of the dual chamber tank 112 are separated by a partition 115. This partition may be movable (e.g., a piston and/or bladder) or fixed. In some embodiments, the partition may be made from metal or some other suitable material. The partition 115 may be arranged to maintain a constant pressure in one or more chambers of the tank despite various unequal volumes and/or amounts of fluid in the one or more chambers. An expansion valve in communication with the dual chamber tank 112 allows the pressure of the fuel held in the first chamber 113 to be reduced for use within the solid oxide fuel cell 110. A CO₂ pump may be used to generate back pressure for the dual chamber tank 112.

In some embodiments, the fuel may be diluted with water to enable a more equal pressure to be achieved between first chamber 113 and the second chamber 114 of the dual chamber tank 112. In some instances, the volume of the liquid CO₂ in the second chamber 114 may exceed the volume of the fuel in the first chamber 113 as the fuel is used to operate the solid oxide fuel cell 110, increasing the volume of the second chamber 114 with respect to the volume of the first chamber 113. The increased volume of the second chamber 114 may reduce the pressure within the second chamber 114. However, in order to maintain the CO2 as a liquid, the pressure of the second chamber 114 should remain above at least approximately 80 bar. Water or another suitable liquid may be provided within first chamber 113 and used to ensure that the volume of the first chamber 113 is not decreased to a level that causes the pressure in the second chamber 114 to drop below 80 bar. In some embodiments, the water may be used to increase the volume of the first chamber 113 by up to 30%. The excess water may help with fuel reforming and any water that is not used for reforming may simply pass through the solid oxide fuel cell 110.

The solid oxide fuel cell pack 105 includes a battery thermal management system 120. In the battery thermal management system 120, the solid oxide fuel cell 110 is thermally and electrically connected to the vehicle battery 102 that provides energy to operate the electric drivetrain for the electric vehicle 100. The battery thermal management system 120 may provide waste heat from the solid oxide fuel cell 110 to help with thermal management of the battery 122 and/or to provide cabin heating for the vehicle. In some embodiments, waste heat from the solid oxide fuel cell 110 may also be used to indirectly cool components for the electric vehicle 100. As an example, waste heat from the solid oxide fuel cell 110 may indirectly allow for cooling by driving a refrigeration system that assists with thermal management of the battery or that assist with vehicle cabin cooling.

Solid oxide fuel cells have a high operating temperature; therefore, heat removal from the solid oxide fuel cell 110 may be desired to effectively control these high operating temperatures. The solid oxide fuel cell pack 105 includes a fuel cell heat removal system 130 that includes various heat transfer fluids in thermal communication with the solid oxide fuel cell 110 to help regulate the temperature of the solid oxide fuel cell 110. In addition to the heat transfer fluids, the solid oxide fuel cell 110 also includes heat fins 111 that encourages heat transfer at the surface of the solid oxide fuel cell 110. In some embodiments, the fuel cell heat removal system 130 may include supercritical CO₂ to remove heat from the solid oxide fuel cell 110. In other embodiments, a pumped water/ammonia mixture or a fuel such as methanol, ethanol, or propane, may be used to remove heat from the solid oxide fuel cell. In still other embodiments, exterior air cooling or the battery thermal management system may be used to remove heat from the solid oxide fuel cell 110.

The solid oxide fuel cell pack 105 includes a fuel reforming system 140. The fuel reforming system 140 is driven by waste heat, either direct or indirect, from the solid oxide fuel cell 110. The supercritical CO₂ that may be used to cool the solid oxide fuel cell 110 in the battery thermal management system 120, may provide heat transferred from the solid oxide fuel cell 110 to assist with fuel boiling, heating, and/or reforming of the fuel that is provided to the solid oxide fuel cell 110 from the dual chamber tank 112. The fuel may be used to directly externally or internally cool the solid oxide fuel cell 110 during the boiling, heating, and/or reforming process.

The solid oxide fuel cell pack 105 includes a condensing system 150. In the condensing system 150, water and/or CO₂ that is produced during the oxidation process at the solid oxide fuel cell 110 is cooled by a radiator. In some embodiments, the radiator may be an air-cooled radiator. This water and/or CO₂ may also be used to preheat the air that is used for oxidation at the solid oxide fuel cell 110. In some embodiments, the thermal management of the battery may also be used to cool the water and/or the CO₂ that is produced by the solid oxide fuel cell 110.

The solid oxide fuel cell pack 105 includes a CO₂ chilling system 160 that operates to reduce the temperature of the CO₂ that is produced by the solid oxide fuel cell and then returned to the dual chamber tank 112. The CO₂ chilling system 160 includes a refrigeration system that is driven directly or indirectly by waste heat from the solid oxide fuel cell 110. In some embodiments, the refrigeration system may use ammonia as a refrigeration fluid so that the refrigeration system operates as an ammonia absorption refrigeration system. The CO₂ chilling system 160 uses cold, condensed CO₂ to pre-cool incoming, gaseous CO₂ before condensation.

The CO₂ chilling system 160 may include a compressor 153 capable to raise the pressure of the CO₂ to allow for condensation. As an example, the compressor 153 may raise the pressure of the CO₂ from 5 bar to 15 bar. In some embodiments, mechanical power from gas expansion that is driven by waste heat from the solid oxide fuel cell 110 may be used to compress the CO₂. After condensation of the CO₂, an exhaust pump 155 is used to increase the pressure of the condensed CO₂. In some embodiments, the exhaust pump 155 may increase the pressure of the CO₂ from 5 bar to a range of 80 to 150 bar. The CO₂ chilling system 160 may be assisted with cooling provided from the HVAC unit of the vehicle 100 or may be assisted with cooling from the battery thermal management system 120. Unused syngas and other gases, such as CO₂ may be recirculated through the solid oxide fuel cell 110.

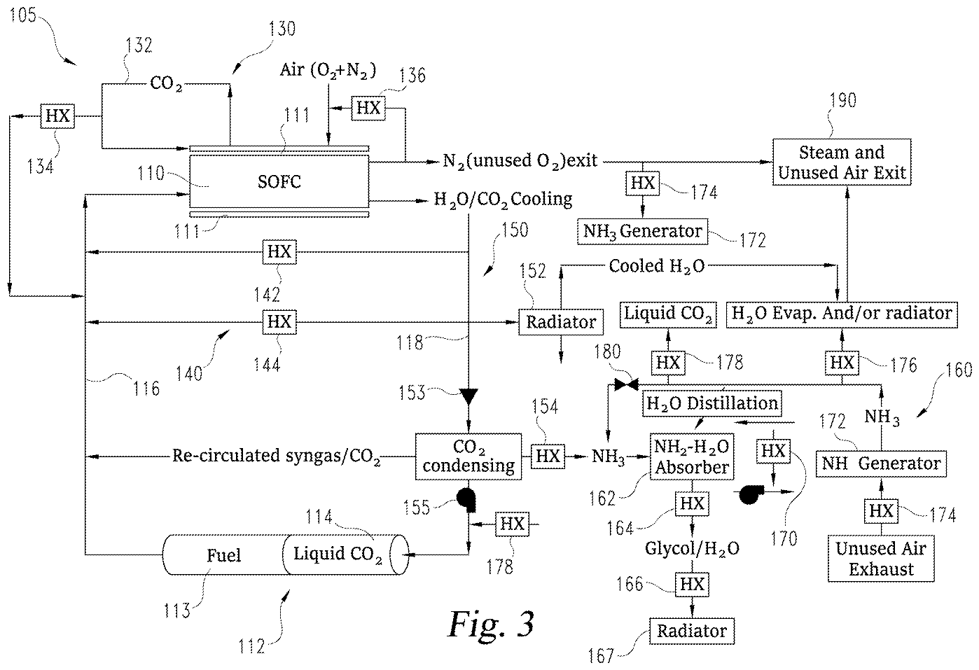

A more detailed diagram of an embodiment of the solid oxide fuel cell pack 105 is shown in FIG. 3. As shown in FIG. 3, the solid oxide fuel cell pack 105 includes the solid oxide fuel cell 110 that has heat fins 111 that assist with cooling the solid oxide fuel cell 110. The solid oxide fuel cell pack 105 also includes the dual chamber tank 112 with first chamber 113 for holding a fuel, such as methanol or ethanol, and second chamber 114 for holding liquid CO₂. A fuel line 116 is fluidly connected between the solid oxide fuel cell 110 and the first chamber 113 of the dual chamber tank 112 to allow fuel to be supplied to the solid oxide fuel cell 110. The solid oxide fuel cell 110 and the second chamber 114 of the dual chamber tank 112 are connected by an exhaust line 118 that removes waste water and that returns waste CO₂ produced by the oxidation process at the solid oxide fuel cell 110 to the dual chamber tank 112.

The fuel cell heat removal system 130 includes a heat transfer loop 132 that may use CO₂ as a heat transfer fluid to absorb heat from and cool the heat fins 111 on the solid oxide fuel cell 110. The battery thermal management system also includes a heat exchanger 134 that takes excess heat that is transferred to the CO₂ from the heat fins 111, and transfers this excess heat from the CO₂ to the fuel in the fuel line 116. This excess heat may be used to assist with heating the fuel within the fuel line 116 to the temperature needed to operate the solid oxide fuel cell 110. The heat exchanger 134 also reduces the temperature of the CO₂ being used as a heat transfer fluid within the heat transfer loop 132 so that the CO₂ is able to absorb more heat from the heat fins 111 to cool the solid oxide fuel cell 110.

The fuel cell heat removal system 130 also includes a heat exchanger 136 that allows for heat transfer between the depleted air that is produced by the solid oxide fuel cell 110 and the air that enters the solid oxide fuel cell 110 to be used for oxidation. In some embodiments, the depleted air is composed of nitrogen and any unused oxygen from the oxidation process. This depleted air may have a temperature of 900° C. when exiting the solid oxide fuel cell 110. The heat exchanger may use some of the heat from this depleted air to be transferred to the incoming air to be used for oxidation to raise the temperature of the incoming air to a suitable level for performing the oxidation process. As an example, the temperature of the incoming air may be increased from 20° C. to over 600° C. In some embodiments, the depleted air may also be used to pre-heat fuel or to assist with ammonia generation. The depleted air may also be directed toward the air side of the tubes in adjacent fuel cells to assist with heating during start-up.

The fuel reforming system 140 includes a heat exchanger 142 that transfers heat from the exhaust CO₂ and water that is produced by the solid oxide fuel cell 110 and transfers the heat to the fuel within the fuel line 116 to increase the temperature of the fuel to be used in the solid oxide fuel cell 110. The heat exchanger 142 is positioned directly after the outlet from the solid oxide fuel cell 110 and therefore, receives the highest temperature exhaust from the solid oxide fuel cell 110. In some embodiments, the exhaust has a temperature of 900° C., and the heat exchanger 142 transfers some of this heat to the fuel within the fuel line 116 right before the fuel enters the solid oxide fuel cell 110. This fuel may be raised from a temperature of 450° C. to 700° C. In some embodiments, some of the exhaust CO₂ and water may be directly recirculated to the fuel line 116 for reforming.

The fuel reforming system 140 also includes a heat exchanger 144 which is positioned after the heat exchanger 142 to further reduce the temperature of the exhaust CO₂ and water (H₂O) from the solid oxide fuel cell 110. The heat exchanger 144 transfers heat from the exhaust in the exhaust line 118 to the fuel in the fuel line 116. The heat transfer to the fuel in the fuel line 116 provides the initial heat that is added to the fuel. In some embodiments, the temperature of the fuel is increased from 20° C. to 350° C. The exhaust water is condensed at the heat exchanger 144 and then sent to a radiator 152 to be further cooled. The remaining CO₂ continues along the exhaust line to be condensed in the condensing system 150.

In the condensing system 150, the exhaust water in the exhaust line 118 is condensed through the transfer of heat to the heat exchangers 142 and 144. The condensed water is sent to the radiator 152 where additional heat is transferred from the exhaust water to the surrounding environment. In some embodiments, the radiator 152 may drop the temperature of the exhaust water from 100° C. to 40° C. The cooled water may then be used as a heat exchange fluid to absorb heat at a heat exchanger 176 that is part of the CO₂ chilling system 160. The exhaust water may then be released from the solid oxide fuel cell pack 105 at an exit 190.

The exhaust CO₂ continues within the exhaust line 118 after going through heat exchanger 144. In some embodiments, a compressor 153 may be used to compress the exhaust CO₂ to assist with the condensing process. The exhaust CO₂ is then cooled at a heat exchanger 154 that is in fluid communication with the CO₂ chilling system 160. Heat from the exhaust CO₂ is transferred at the heat exchanger 154 to a refrigeration system that cools the CO₂ a sufficient amount to condense the exhaust CO₂. In some embodiments, the heat transfer fluid that is used at the heat exchanger 154 is ammonia. In some embodiments the exhaust CO₂ may be cooled from a temperature of 40° C. to a temperature of −30° C. after running through heat exchanger 154.

Recirculated syngas and CO₂ which does not condense at the heat exchanger 154 may be returned to the fuel line 116 and inserted directly into the solid oxide fuel cell 110 without using reformer tubes. The recirculated syngas may be directed towards alternate reformer tubes using different catalysts. Recirculated syngas may also bypass some portion of the heat exchanger and be injected into the solid oxide fuel cell 110 interstitially to provide additional cooling to hotspots in the solid oxide fuel cell. The recirculated syngas and CO₂ may also be recombined with the fuel to provide the CO₂ which is needed for reforming and to reform fuel which may have not been reformed during the previous cycle.

After condensing, the exhaust CO₂ may enter a pump 155 where the exhaust CO₂ is pressurized. In some embodiments, the CO₂ may be pressurized to 80 bar. Before entering the dual chamber tank 112, the exhaust CO₂ is in fluid communication with a heat exchanger 178 from the CO₂ chilling system 160 that raises the temperature of the exhaust CO₂. In some embodiments, the exhaust CO₂ may enter the heat exchanger 178 at a temperature of −30° C. and exit the heat exchanger 178 at a temperature of 15° C.

The CO₂ chilling system 160 uses ammonia as a refrigerant. The ammonia interacts with the CO₂ at the heat exchanger 154 heat from the exhaust CO₂. In some embodiments, the ammonia enters the heat exchanger 154 at a temperature of −30° C. After the ammonia has absorbed heat from the exhaust CO₂, the ammonia is sent to an ammonia-water absorber 162. At the ammonia-water absorber 162, the ammonia is absorbed by water to create an ammonia-water mixture. The ammonia-water absorber 162 is in fluid communication with the heat exchanger 164, so that the heat exchanger 164 may use a heat transfer fluid, such as a glycol-water solution, to absorb heat that is created from forming the ammonia-water mixture. Another heat exchanger 166 may be in fluid communication with heat transfer fluid from the heat exchanger 164 to remove the heat from the heat transfer fluid. The heat exchanger 166 may include a radiator 167 that gets rid of the heat to the surrounding environment.

The ammonia-water mixture may then be pumped by a pump 168 that pressurizes and increases the temperature of the ammonia-water mixture. A heat exchanger 170 may transfer heat to the ammonia-water mixture at the pump 168 to increase the temperature of the ammonia-water mixture. In some embodiments, the temperature of the ammonia-water mixture may increase in temperature from 30° C. to 70° C. The heat from the heat exchanger 170 is provided by water exiting an ammonia generator 172. In some embodiments, the water exiting the ammonia generator 172 is cooled from a temperature of 100° C. to 40° C.

The ammonia-water mixture may then be pumped by a pump 168 that pressurizes the ammonia-water mixture. A heat exchanger 170 may transfer heat to the ammonia-water mixture at the pump 168 to increase the temperature of the ammonia-water mixture. In some embodiments, the temperature of the ammonia-water mixture may increase in temperature from 30° C. to 70° C. The heat from the heat exchanger 170 is provided by water exiting an ammonia generator 172. In some embodiments, the water exiting the ammonia generator 172 is cooled from a temperature of 100° C. to 40° C.

The ammonia generator 172 is in fluid communication with a heat exchanger 174. This heat exchanger 174 uses unused air exhaust as the heat, boiler, or generator for the ammonia generator 172. In some embodiments, the unused air exhaust may include the depleted air that is discharged from the solid oxide fuel cell 110 and that is not used to heat incoming air for the solid oxide fuel cell 110 at heat exchanger 136. The heat from the depleted air may be used to provide the heat necessary to generate ammonia at the ammonia generator 172.

The ammonia that is produced at the ammonia generator 172 is sent to the heat exchanger 176 that was discussed above with regard to the condensing system 150. At the heat exchanger 176, the ammonia transfers heat, and in some embodiments, to evaporate the exhaust water in the condensing system 150. In some embodiments, the temperature of the ammonia before heat exchanger 176 is 150° C. and after the heat exchanger 176, the temperature of the ammonia is dropped to 40° C.

After the heat exchanger 176, water is condensed and distilled from the ammonia and sent to the ammonia-water absorber 162. The ammonia then encounters another heat exchanger 178 to further cool the ammonia. The heat exchanger 178 may use the liquid CO₂ from the exhaust line 118 as a heat transfer fluid to absorb heat from the ammonia. Therefore, the ammonia in the CO₂ chilling system is cooled while the condensed, liquid CO₂ from the exhaust line 118 is warmed before being stored in the dual chamber tank 112. The ammonia then goes through an expander 180 to depressurize the ammonia after it is cooled at the heat exchanger 178 and to further cool the ammonia before it enters heat exchanger 154 to condense the CO₂ in the exhaust line 118.

In some embodiments, certain rules may govern when the solid oxide fuel cell packs 105 are operated to provide electric power to recharge the battery 102 and/or to power the vehicle 100. These standards may take into account the battery capacity, the average speed of the battery, and/or the number of solid oxide fuel cell packs 105 to activate. In some embodiments, one or more of the solid oxide fuel cells 110 from the solid oxide fuel cell packs 105 may be activated to recharge the battery 102 or to power the vehicle 100 when the battery capacity is below a threshold value and the electric vehicle has maintained a minimum average speed for a predetermined amount of time.

In a standard mode of operation, several rules are applied to determine when to activate one or more of the solid oxide fuel cell packs 105. As an example, the solid oxide fuel cell packs 105 are activated if more than 40% of the battery capacity is depleted, and for the most recent 25% of the battery charge duration, the vehicle 100 had an average speed of greater than 50 miles per hour. In this situation, less than half of the total number of solid oxide fuel cell packs 105 in the vehicle are activated to recharge the battery 102.

If more than 60% of the battery capacity is depleted, and for the most recent 25% of the battery charge duration, the vehicle 100 had an average speed of less than 40 miles per hour, then less than half of the total number of solid oxide fuel cell packs 105 in the vehicle are activated to recharge the battery 102. However, if more than 60% of the battery capacity is depleted, and for the most recent 25% of the battery charge duration, the vehicle 100 had an average speed of greater than 40 miles per hour, then more than half of the total number of solid oxide fuel cell packs 105 in the vehicle are activated to recharge the battery 102. If more than 80% of the battery capacity is depleted, then all of the solid fuel oxide cell packs 105 are engaged to recharge the battery 102.

If desired, the standard mode of operation may be overridden by a driver operating the vehicle 100. As an example, the driver may decide to engage a manual mode in which the solid oxide fuel cell packs 105 are engaged at the discretion of the driver. The driver may also choose to operate the vehicle 100 in a commuter mode, in which the solid oxide fuel cell packs will not engage until the battery 102 is at less than 25% of capacity. In another example, the vehicle 100 may operate in a road trip mode, in which one half or less of the solid oxide fuel cell packs 105 engage immediately upon the start of a trip, and the rest of the solid oxide fuel cell packs 105 will engage when the battery is at less than 65% of capacity. It should be recognized that other desired modes may be available in which one or more of the solid oxide fuel cell packs are engaged or disengaged based on the capacity of the battery, the speed of the vehicle, or any other suitable characteristic of the vehicle.

In some embodiments, the solid oxide fuel cell pack 105 uses a tubular solid oxide fuel cell 110. The tubular solid oxide fuel cell 110 has air on the tube side and syngas on the outside. The tubes of the solid oxide fuel cell 110 may be vertically oriented with one or more reformer tubes included to facilitate flow through the solid oxide fuel cell 110. The fuel inside the reformer tubes may cool the solid oxide fuel cell 110 by utilizing waste heat and receive additional heating from inside the solid oxide fuel cell box. The syngas on the outside of the solid oxide fuel cell 110 may be redirected outside of the solid oxide fuel cell 110 before reentry. Alternatively, reformer tube holes or slits may allow syngas to enter into the solid oxide fuel cell 110 directly.

Because it is common for solid oxide fuel cells to suffer from hot spots, some of the solid fuel oxide cells 110 may have recirculated syngas and CO₂, as described above. Some low temperature syngas, which may not require reforming, may enter the solid oxide fuel cell 110. This syngas may be released inside the solid oxide fuel cell 110 through holes or slits.

The solid oxide fuel cell pack 105 may also include additional tubes that are filled with air, but which are not solid oxide fuel cells. These tubes may be used for the final heating stage of the air that enters the solid fuel oxide cell pack 105 and may provide cooling to specific portions of the solid oxide fuel cell 110.

The language used in the claims and the written description is to only have its plain and ordinary meaning, except for terms explicitly defined below. Such plain and ordinary meaning is defined here as inclusive of all consistent dictionary definitions from the most recently published (on the filing date of this document) general purpose Merriam-Webster dictionary.

As used in the claims and the specification, the following terms have the following defined meanings:

The term “battery” as used herein means one or more cells connected together to furnish electric current. The term includes cells in which chemical energy is converted into electricity.

The term “fuel cell” as used herein means an electrochemical conversion device that produces electricity from oxidizing a fuel. The term includes solid oxide fuel cells. The term includes one or more fuel cells in a “pack”. Such packs may define one or more inlet connections to supply fuel to the fuel cell and/or one or more outlet connections to remove a byproduct from the fuel cell. Packs may provide thermal insulation for the fuel cell and/or include a heat exchanger to facilitate heat transfer with the fuel cell. Packs may also include a housing configured for mounting the fuel cell within a vehicle.

The following numbered clauses set out specific embodiments that may be useful in understanding the present invention:

1. A system comprising:
a solid oxide fuel cell;
a fuel tank, wherein said fuel tank includes at least a first chamber separate from a second chamber;
a fuel line extending between said fuel tank and said solid oxide fuel cell, wherein said fuel line is configured to supply fuel from the first chamber of said fuel tank to said solid oxide fuel cell;
an exhaust line extending between said fuel tank and said solid oxide fuel cell, wherein said exhaust line is configured to return exhaust fluid including CO₂ from said solid oxide fuel cell to said second chamber of said fuel tank;
a refrigeration system in thermal communication with the exhaust line, wherein said refrigeration system includes ammonia as a heat transfer fluid;
wherein said refrigeration system is configured to condense the CO₂ in the exhaust line; and
wherein the condensed CO₂ is stored in said second chamber of said fuel tank as a liquid.
   2. The system of clause 1, wherein the exhaust fluid in said exhaust line is a mixture of CO₂ and water.
   3. The system of any one of clauses 1-2, wherein syngas is recirculated from said exhaust line to said fuel line to be used as fuel for said solid oxide fuel cell.
   4. The system of any one of clauses 1-3, further comprising:
a heat exchanger in fluid communication with said exhaust line and said fuel line; and
   wherein said heat exchanger is configured to transfer heat from the exhaust fluid in said exhaust line to the fuel in said fuel line to increase a temperature of the fuel in said fuel line.
      5. The system of any one of clauses 1-4, wherein said solid oxide fuel cell includes heat fins.
      6. The system of clause 5,
wherein a heat transfer loop including CO₂ as a heat transfer fluid absorbs heat from said solid oxide fuel cell at said heat fins; and
wherein the heat absorbed by the CO2 is transferred to the fuel in said fuel line.
   7. The system of any one of clauses 1-6, wherein the first chamber of said fuel tank and the second chamber of the fuel tank are separated by a movable partition.
   8. The system of any one of clauses 1-7, wherein said fuel is ethanol.
   9. A system comprising:
a solid oxide fuel cell;
a fuel tank, wherein said fuel tank includes two separate chambers and a movable separator between said two separate chambers;
a fuel line extending between said fuel tank and said solid oxide fuel cell, wherein said fuel line is configured to supply fuel from said fuel tank to said solid oxide fuel cell;
an exhaust line extending between said fuel tank and said solid oxide fuel cell, wherein said exhaust line is configured to return exhaust fluid including CO₂ from said solid oxide fuel cell to said fuel tank; and
a refrigeration system in thermal communication with the exhaust line, wherein said refrigeration system is configured to condense the CO₂ in the exhaust line.
   10. The system of clause 9, wherein the two separate chambers of said fuel tank are formed by a metal partition.
   11. The system of any one of clauses 9-10, wherein the two separate chambers of said fuel tank are formed by a bladder.
   12. The system of any one of clauses 9-11, wherein one of said two separate chambers stores liquid CO₂.
   13. The system of clause 12, further comprising:
an exhaust pump, wherein said exhaust pump is in fluid communication with said exhaust line; and
wherein said exhaust pump is configured to create back pressure within said fuel tank.
   14. The system of clause 12, wherein said fuel tank is configured to maintain a pressure in first and/or second chambers of said fuel tank when the two chambers have unequal volumes.
   15. A method of operating an electric vehicle, comprising
providing power to drive the electric vehicle, wherein the power is provided by a battery having a battery capacity;
activating one or more of a plurality of solid oxide fuel cells to recharge the battery, wherein said plurality of solid oxide fuel cells are electrically connected to said battery;
wherein the one or more of said plurality of solid oxide fuel cells are activated when the battery capacity is below a threshold value and the electric vehicle has maintained a minimum average speed for a predetermined amount of time.
   16. The method of clause 15,
wherein at least one of the plurality of solid oxide fuel cells is activated to recharge the battery when more than 40% of the battery capacity is depleted;
wherein the predetermined amount of time is the duration of the most recent 25% battery capacity used; and
wherein the electric vehicle had an average speed of greater than 50 miles per hour for said predetermined amount of time.
   17. The method of clause 16, wherein less than half of the total number of the plurality of solid oxide fuel cells are activated.
   18. The method of any one of clauses 15-17,
wherein at least one of the plurality of solid oxide fuel cells is activated to recharge the battery when more than 60% of the battery capacity is depleted;
wherein the predetermined amount of time is the duration of the most recent 25% of the battery capacity used; and
wherein the electric vehicle had an average speed of less than 40 miles per hour for said predetermined amount of time.
   19. The method of any one of clauses 15-18,
wherein at least half of the plurality of solid oxide fuel cells are activated to recharge the battery when more than 60% of the battery capacity is depleted;
wherein the predetermined amount of time is the duration of the most recent 25% of the battery capacity used; and
wherein the electric vehicle had an average speed of greater than 40 miles per hour for said predetermined amount of time.
   20. The method of any one of clauses 15-19, wherein all of the plurality of solid oxide fuel cells are activated to recharge the battery when more than 80% of the battery capacity is depleted.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A system comprising:
a solid oxide fuel cell;
a fuel tank, wherein said fuel tank includes at least a first chamber separate from a second chamber;
a fuel line extending between said fuel tank and said solid oxide fuel cell, wherein said fuel line is configured to supply fuel from the first chamber of said fuel tank to said solid oxide fuel cell;
an exhaust line extending between said fuel tank and said solid oxide fuel cell, wherein said exhaust line is configured to return exhaust fluid including CO₂ from said solid oxide fuel cell to said second chamber of said fuel tank;
a refrigeration system in thermal communication with the exhaust line, wherein said refrigeration system includes ammonia as a heat transfer fluid;
wherein said refrigeration system is configured to condense the CO₂ in the exhaust line; and
wherein the condensed CO₂ is stored in said second chamber of said fuel tank as a liquid.

2. The system of claim 1, wherein the exhaust fluid in said exhaust line is a mixture of CO₂ and water.

3. The system of claim 1, wherein syngas is recirculated from said exhaust line to said fuel line to be used as fuel for said solid oxide fuel cell.

4. The system of claim 1, further comprising:
a heat exchanger in fluid communication with said exhaust line and said fuel line; and
wherein said heat exchanger is configured to transfer heat from the exhaust fluid in said exhaust line to the fuel in said fuel line to increase a temperature of the fuel in said fuel line.

5. The system of claim 1, wherein said solid oxide fuel cell includes heat fins.

6. The system of claim 5,
wherein a heat transfer loop including CO₂ as a heat transfer fluid absorbs heat from said solid oxide fuel cell at said heat fins; and
wherein the heat absorbed by the CO2 is transferred to the fuel in said fuel line.

7. The system of claim 1, wherein the first chamber of said fuel tank and the second chamber of the fuel tank are separated by a movable partition.

8. The system of claim 1, wherein said fuel is ethanol.

9-20. (canceled)

21. A system comprising:
a solid oxide fuel cell;
a fuel tank, wherein said fuel tank includes two separate chambers and a movable separator between said two separate chambers;
a fuel line extending between said fuel tank and said solid oxide fuel cell, wherein said fuel line is configured to supply fuel from said fuel tank to said solid oxide fuel cell;
an exhaust line extending between said fuel tank and said solid oxide fuel cell, wherein said exhaust line is configured to return exhaust fluid including CO₂ from said solid oxide fuel cell to said fuel tank; and
a refrigeration system in thermal communication with the exhaust line, wherein said refrigeration system is configured to condense the CO₂ in the exhaust line.

22. The system of claim 21, wherein the two separate chambers of said fuel tank are formed by a metal partition.

23. The system of claim 21, wherein the two separate chambers of said fuel tank are formed by a bladder.

24. The system of claim 21, wherein one of said two separate chambers stores liquid CO₂.

25. The system of claim 24, further comprising:
an exhaust pump, wherein said exhaust pump is in fluid communication with said exhaust line; and
wherein said exhaust pump is configured to create back pressure within said fuel tank.

26. The system of claim 24, wherein said fuel tank is configured to maintain a pressure in first and/or second chambers of said fuel tank when the two chambers have unequal volumes.

27. A method of operating an electric vehicle, comprising
providing power to drive the electric vehicle, wherein the power is provided by a battery having a battery capacity;
activating one or more of a plurality of solid oxide fuel cells to recharge the battery, wherein said plurality of solid oxide fuel cells are electrically connected to said battery;
wherein the one or more of said plurality of solid oxide fuel cells are activated when the battery capacity is below a threshold value and the electric vehicle has maintained a minimum average speed for a predetermined amount of time.

28. The method of claim 27,
wherein at least one of the plurality of solid oxide fuel cells is activated to recharge the battery when more than 40% of the battery capacity is depleted;
wherein the predetermined amount of time is the duration of the most recent 25% battery capacity used; and
wherein the electric vehicle had an average speed of greater than 50 miles per hour for said predetermined amount of time.

29. The method of claim 28, wherein less than half of the total number of the plurality of solid oxide fuel cells are activated.

30. The method of claim 27,
wherein at least one of the plurality of solid oxide fuel cells is activated to recharge the battery when more than 60% of the battery capacity is depleted;
wherein the predetermined amount of time is the duration of the most recent 25% of the battery capacity used; and
wherein the electric vehicle had an average speed of less than 40 miles per hour for said predetermined amount of time.

31. The method of claim 27,
wherein at least half of the plurality of solid oxide fuel cells are activated to recharge the battery when more than 60% of the battery capacity is depleted;
wherein the predetermined amount of time is the duration of the most recent 25% of the battery capacity used; and
wherein the electric vehicle had an average speed of greater than 40 miles per hour for said predetermined amount of time.

32. The method of claim 27, wherein all of the plurality of solid oxide fuel cells are activated to recharge the battery when more than 80% of the battery capacity is depleted.
